(19) United States
(12) Patent Application Publication
(10) Pub. No.: US 2003/0191040 A1
(43) Pub. Date: Oct. 9, 2003

(54) Liquid cleaning compositions and their use

(75) Inventors: Arend Jan Adriaanse, Vlaardingen (NL); Willem Robert Van Dijk, Vlaardingen (NL); Ronald Hage, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/397,413

(22) Filed: Mar. 26, 2003

(30) Foreign Application Priority Data
Mar. 28, 2002 (GB) 0207430.0

(51) Int. Cl. C11D 3/386

(52) U.S. Cl. 510/267; 510/392; 510/530

(57) ABSTRACT

An aqueous liquid cleaning composition comprising a proteolytic enzyme and a primary stabiliser therefor, the composition further comprising a polyoxometalate.

### FIELD OF INVENTION

The present invention relates to liquid cleaning compositions containing proteolytic enzymes and stabilising systems for those enzymes. It also relates to methods of using such compositions for the cleaning of substrates.

### BACKGROUND OF INVENTION

In liquid detergent compositions, especially those for the washing of textile fabrics, it is common to include one or more enzymes for assisting removal of various kinds of soil. Amongst these are proteolytic enzymes, often referred to as “proteases”. Proteases are used to assist in removal of protein-based soil. However, the very nature and activity of these enzymes means that they attack any other component in the liquid composition which has a protein-like structure. As a result, they can degrade other enzymes in the liquid,.as.well as undergoing self-degradation. To counteract this, it is usual also to incorporate an enzyme stabilising system. Such stabiliser systems commonly consist of a boron compound, eg. borax, together with a polyol, eg. glycerol or sorbitol. These components are believed to form an enzyme-inhibiting complex by dilution of the composition into the wash liquor, disabling the inhibiting effect so that the protease can act upon the proteinaceous soil.

Other protease stabilisers such as calcium chloride/calcium formate are also known but are not as effective as those systems based on boron. However, for environmental reasons, it is desired to reduce the amount of boron in the composition.

The specification of WO 00/12677 discloses compositions and methods for catalytically bleaching substrates with atmospheric oxygen, using a metal-ligand complex as catalyst. These complexes allow catalytic bleaching by atmospheric oxygen without inclusion of peroxygen bleaches.

Peroxygen bleaches are well known for their ability to remove stains from substrates. Traditionally, the substrate is subjected to hydrogen peroxide, or to substances which can generate hydroperoxyl radicals, such as inorganic or organic peroxides. Generally, these systems must be activated. One method of activation is to employ wash temperatures of 60° C. or higher. However, these high temperatures often lead to inefficient cleaning, and can also cause premature damage to the substrate.

A preferred approach to generating hydroperoxyl bleach species is the use of inorganic peroxides coupled with organic precursor compounds. These systems are employed for many commercial laundry powders. For example, various European systems are based on tetraacetyl ethylenediamine (TAED) as the organic precursor coupled with sodium perborate or sodium percarbonate, whereas in the United States laundry bleach products are typically based on sodium nonanoyloxybenzenesulphonate (SNOBS) as the organic precursor coupled with sodium perborate.

In conventional liquid detergent compositions, it has long been known that peroxygen bleaches and enzymes interact such that they cannot be incorporated together and yet remain stable. A number of ways of mitigating this unwanted interaction have been described but they are either costly and difficult to implement or are only partially successful.

Since the atmospheric oxygen bleach catalysts work to catalyse bleaching activity of the dissolved atmospheric oxygen in any liquid in which they are incorporated, it can be expected that in liquid detergent compositions containing enzymes, they will catalyse the dissolved oxygen to attack those enzymes. However, surprisingly, it has now been found that polyoxometalates boost the stabilising effect of conventional kinds of enzyme stabiliser. This enables the amount of conventional stabiliser to be reduced.

CA-A-2 183 814 (Reinhardt et al.) reports use of polyoxometalates as bleaching catalysts for removal of stains from fabrics. The process requires an active-oxygen agent which may be hydrogen peroxide, organic peracids, inorganic peracids, organic persalts or inorganic persalts. Molecular oxygen or air are not mentioned as the oxidation source. However, the use of such materials as molecular oxygen or air bleaches without an active bleach source is disclosed in EP-A-1 141 210.

WO-A-98/20101 (Mishra et al.) reports use of tungsten salts for catalyzing bleaching by hydrogen peroxide, percarbonates, perborates, various hydrogen peroxide adducts and mixtures thereof. Likewise, this disclosure requires that the source of oxygen be a liquid or a solid peroxy chemical.

### SUMMARY OF INVENTION

A first aspect of the present invention an aqueous liquid cleaning composition comprising a proteolytic enzyme and a primary stabiliser therefor, the composition further comprising a polyoxometalate.

A second aspect of the invention provides a method of cleaning a substrate comprising applying to the substrate, an aqueous liquid cleaning composition according the first aspect of the present invention.

In a third aspect, the present invention provides Use of a polyoxometalate as a secondary enzyme stabiliser in an aqueous liquid detergent composition comprising a proteolytic enzyme and a primary stabiliser therefor.

### DETAILED DESCRIPTION OF THE INVENTION

The Liquid Detergent Composition

Liquid detergent compositions generally can be considered either to be isotropic or structured.

The liquid cleaning composition may be formulated as a concentrated cleaning liquid for direct application to a substrate, or for application to a substrate following dilution, such as dilution before or during use of the liquid composition by the consumer or in washing apparatus.

Whilst the composition and method according to the present invention may be used for cleaning any suitable substrate, the preferred substrate is a laundry fabric. Cleaning may be carried out by simply leaving the substrate in contact for a sufficient period of time with a bleach medium constituted by or prepared from the liquid cleaning composition. Preferably, however, the cleaning medium on or containing the substrate is agitated.

Product Form

The liquid cleaning composition according the present invention is preferably a concentrated liquid cleaning composition. In one aspect of the invention the liquid cleaning composition is isotropic. In another aspect of the invention the liquid detergent composition is structured. It should be understood that the liquid compositions according to any aspect of the present invention have a physical form which preferably ranges from a pourable liquid, a pourable gel to a non-pourable gel. These forms are conveniently characterised by the product viscosity. In these definitions, and unless indicated explicitly to the contrary, throughout this specification, all stated viscosities are those measured at a shear rate of 21 s⁻¹ and at a temperature of 25° C.

Compositions according to any aspect of the present invention preferably have a viscosity of no more than 1,500 mPa.s, more preferably no more than 1,000 mPa.s, still more preferably, no more than 500 mPa.s.

Compositions according to any aspect of the present invention which are pourable gels, preferably have a viscosity of at least 1,500 mPa.s but no more than 6,000 mPa.s, more preferably no more than 4,000 mpa.s, still more preferably no more than 3,000 mpa.s and especially no more than 2,000 mPa.s.

Compositions according to any aspect of the present invention which are non-pourable gels, preferably have a viscosity of at least 6,000 mPa.s but no more than 12,000 mPa.s, more preferably no more than 10,000 mpa.s, still more preferably no more than 8,000 mPa.s and especially no more than 7,000 mpa.s.

Physically Stable

For the purpose of this invention a composition is physically stable when less than 2% phase separation occurs after 2 week storage at 37° C. With isotropic liquids this phase separation generally starts with the liquid becoming hazy.

Water

Preferably the amount of water in the liquid detergent composition is from 5 to 95%, more preferred from 25 to 75%, most preferred from 30 to 50%. Especially preferred less than 45% by weight.

I Isotropic Liquid Cleaning Compositions

Isotropic liquid cleaning compositions are defined for the present purpose as liquid detergent compositions wherein the surfactants do not form liquid crystalline phases, like multi-lamellar droplets of surfactant material. Isotropic liquids are generally not birefringent under static conditions but may be birefringent under flow.

Ia Surfactant

Typically, the isotropic compositions herein comprise from 1 to 90%,preferably from 10 to 70% by weight of an anionic, nonionic, cationic, zwitterionic active detergent material or mixtures thereof. Preferably the compositions herein comprise 12 to 60% of surfactant, more preferably 15 to 40%.

Non-limiting examples of other surfactants useful herein typically at levels from about 10% to about 70%, by weight, include the conventional C11-C18 alkylbenzene sulphonates (“LAS”), the C10-C18 secondary (2,3) alkyl sulphates of the formula CH3(CH2)ₓ(CHOS03-M+)CH3 and CH3(CH2)_{y}(CHOS03-M+)CH2CH3 where x and (y+1) are integers of at least about 7, preferably at least about 9, and M is a water-solubilising cation, especially sodium, unsaturated sulphates such as oleyl sulphate, C10-C18 alkyl alkoxy carboxylates (especially the EO 1-7 ethoxycarboxylates), the C10-C18 glycerol ethers, the C10-C18alkyl polyglycosides and their corresponding sulphated polyglycosides, and C12-C18 alpha-sulphonated fatty acid esters. If desired, the conventional nonionic and amphoteric surfactants such as the C12-C18 alkyl ethoxylates (“AE”) including the so-called narrow peaked alkyl ethoxylates and C6-C12 alkyl phenol alkoxylates (especially ethoxylates and mixed ethoxy/propoxy), C12-C18 betaines and sulphobetaines (“sultaines”), C10-C18 amine oxides, and the like, can also be included in the overall compositions. The C10-C18 N-alkyl polyhydroxy fatty acid amides can also be used. Typical examples include the C12-C18 N-methylglucamides. See WO 9,206,154. Other sugar-derived surfactants include the N-alkoxy polyhydroxy fatty acid amides, such as C10-C18 N-(3-methoxypropyl) glucamide. C10-C20 conventional soaps may also be used. If high sudsing is desired, the branched-chain C10-C16 soaps may be used.

Mixtures of anionic and nonionic surfactants are especially useful. Other conventional useful surfactants are listed in standard texts.

Other anionic surfactants useful for detersive purposes can also be included in the isotropic compositions hereof. These can include salts (including, for example, sodium potassium, ammonium, and substituted ammonium salts such a mono-, di- and triethanolamine salts) of soap, C9-C20 linear alkylbenzenesulphonates, C8-C22 primary or secondary alkanesulphonates, C8-C24 olefinsulphonates, sulphonated polycarboxylic acids, alkyl glycerol sulphonates, fatty acyl glycerol sulphonates, fatty oleyl glycerol sulphates, alkyl phenol ethylene oxide ether sulphates, paraffin sulphonates, alkyl phosphates, isothionates such as the acyl isothionates, N-acyl taurates, fatty acid amides of methyl tauride, alkyl succinamates and sulphosuccinates, monoesters of sulphosuccinate (especially saturated and unsaturated C12-C18 monoesters) diesters of sulphosuccinate (especially saturated and unsaturated C6-C14 diesters), N-acyl sarcosinates, sulphates of alkylpolysaccharides such as the sulphates of alkylpolyglucoside, branched primary alkyl sulphates, alkyl polyethoxy carboxylates such as those of the formula RO(CH2CH20)ₖCH2COO-M+ wherein R is a C8-C22 alkyl, k is an integer from 0 to 10, and M is a soluble salt-forming cation, and fatty acids esterified with isethionic acid and neutralised with sodium hydroxide. Further examples are given in Surface Active Agents and Detergents (Vol. I and II by Schwartz, Perry and Berch).

The isotropic compositions of the present invention preferably comprise at least about 5%, preferably at least 10%, more preferably at least 12% and less than 70%, more preferably less than 60% by weight, of an anionic surfactant.

Alkyl sulphate surfactants, either primary or secondary, are a type of anionic surfactant of importance for use herein. Alkyl sulphates have the general formula ROS03M wherein R preferably is a C10-C24 hydrocarbyl, preferably an alkyl straight or branched chain or hydroxyalkyl having a C10-C20 alkyl component, more preferably a C12-C18 alkyl or hydroxyalkyl, and M is hydrogen or a water soluble cation, e.g., an alkali metal cation (e.g., sodium potassium, lithium), substituted or unsubstituted ammonium cations such as methyl-, dimethyl-, and trimethyl ammonium and quaternary ammonium cations, e.g., tetramethyl-ammonium and dimethyl piperdinium, and cations derived from alkanolamines such as ethanolamine, diethanolamine, triethanolamine, and mixtures thereof, and the like.

Typically, alkyl chains Of C12-C16 are preferred for lower wash temperatures (e.g., below about 50° C. and C16-C18 alkyl chains are preferred for higher wash temperatures (e.g., about 50° C.).

Alkyl alkoxylated sulphate surfactants are another category of preferred anionic surfactant. These surfactants; are water soluble salts or acids typically of the formula RO(A)mSO3M wherein R is an unsubstituted C10-C24 alkyl or hydroxyalkyl group having a C10-C24 alkyl component, preferably a C12-C20 alkyl or hydroxyalkyl, more preferably C12-C18 alkyl or hydroxyalkyl, A is an ethoxy or propoxy unit, m is greater than zero, typically between about 0.5 and about 6, more preferably between about 0.5 and about 3, and M is hydrogen or a water soluble cation which can be, for example, a metal cation (e.g., sodium, potassium, lithium, calcium, magnesium, etc.), ammonium or substituted-ammonium cation. Alkyl ethoxylated sulphates as well as alkyl propoxylated sulphates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines, e.g., monoethanolamine, diethanolamine, and triethanolamine, and mixtures thereof. Exemplary surfactants are C12-C18 alkyl polyethoxylate (1.0) sulphate, C12-C18 alkyl polyethoxylate (2.25) sulphate, C12-C18 alkyl polyethoxylate (3.0) sulphate, and C12-C18 alkyl polyethoxylate (4.0) sulphate wherein M is conveniently selected from sodium and potassium.

The isotropic compositions of the present invention preferably comprise at least about 5%, preferably at least 10%, more preferably at least 12%. and less than 70%, more preferably less than 60% by weight, of a nonionic surfactant.

Preferred nonionic surfactants such as C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6 to C12 alkyl phenols, alkylene oxide condensates of C8-C22 alkanols and ethylene oxide/propylene oxide block polymers (Pluronic™-BASF Corp.), as well as semi polar nonionics (e.g., amine oxides and phosphine oxides) can be used in the present isotropic compositions. An extensive disclosure of these types of surfactants is found in U.S. Pat. 3,929,678.

Alkylpolysaccharides such as disclosed in U.S. Pat. 4,565,647 are also preferred nonionic surfactants in the isotropic compositions of the invention.

Further preferred nonionic surfactants are the polyhydroxy fatty acid amides.

A particularly desirable surfactant of this type for use in the isotropic compositions herein is alkyl-N-methyl glucamide.

Other sugar-derived surfactants include the N-alkoxy polyhydroxy fatty acid amides, such as C10-C18 N-(3-methoxypropyl) glucamide. The N-propyl through N-hexyl C12-C18 glucamides can be used for low sudsing. C10-C20 conventional soaps may also be used. If high sudsing is desired, the branched-chain C10-C16 soaps may be used.

Another preferred anionic surfactant is a salt of fatty acids. Examples of fatty acids suitable for use of the present invention include pure or hardened fatty acids derived from palmitoleic, safflower, sunflower, soybean, oleic, linoleic, linolenic, ricinoleic, rapeseed oil or mixtures thereof. Mixtures of saturated and unsaturated fatty acids can also be used herein.

It will be recognised that the fatty acid will be present in the liquid detergent isotropic composition primarily in the form of a soap. Suitable cations include, sodium, potassium, ammonium, monoethanol ammonium diethanol ammonium, triethanol ammonium, tetraalkyl ammonium, e.g., tetra methyl ammonium up to tetradecyl ammonium etc. cations.

The amount of fatty acid will vary depending on the particular characteristics desired in the final detergent isotropic composition. Preferably 0 to 30%, more preferably 1-20 most preferably 5-15% fatty acid is present in the inventive isotropic composition.

Ib Carriers

Isotropic liquid detergent compositions can contain water and other solvents as carriers. Low molecular weight primary or secondary alcohols exemplified by methanol, ethanol, propanol, and isopropanol are suitable. Monohydric alcohols are preferred for solubilising surfactant. The compositions may contain from 5% to 90%, typically 10% to 50% of such carriers.

Ic Clarity

The clarity of the isotropic compositions according to the present invention does not preclude the isotropic composition being coloured, e.g. by addition of a dye, provided that it does not detract substantially from clarity. Moreover, an opacifier could be included to reduce clarity if required to appeal to the consumer. In that case the definition of clarity applied to the isotropic composition according to any aspect of the invention will apply to the base (equivalent) isotropic composition without the opacifier.

II Structured Liquid Cleaning Compositions

IIa Form of Structuring

Conventionally, liquid cleaning compositions may be structured in one of two different ways to endow consumer-preferred flow behaviour and/or turbid appearance and/or of suspending particulate solids such as detergency builders or abrasive particles.

The first way is to employ an “external structurant” such as a gum or polymer thickener. The second way is to form a lamellar phase “internal structure” from the surfactant(s) and water, the latter usually containing dissolved electrolyte.

Lamellar phases are a particular class of surfactant structures which, inter alia, are already known from a variety of references, e.g. H. A. Barnes, ‘Detergents’, Ch. 2 in K. Walters (Ed), Rheometry: Industrial Applications', J. Wiley & Sons, Letchworth 1980.

Lamellar phases can themselves be considered as divided into the sub-classes planar lamellar phases and lamellar droplets. Products can contain exclusively planar lamellar phases or exclusively lamellar droplets or the two forms can co-exist in the same product.

The presence of lamellar phases in a liquid detergent product may be detected by means known to those skilled in the art, for example optical techniques, various rheometrical measurements, X-ray or neutron diffraction, and electron microscopy.

Lamellar droplets consist of an onion-like configuration of concentric bi-layers of surfactant molecules, between which is trapped water or electrolyte solution (aqueous phase). Systems in which such droplets are close-packed provide a very desirable combination of physical stability and solid-suspending properties with useful flow properties.

Examples of internally structured liquids containing a dispersion of lamellar droplets but without suspended solids are given in U.S. Pat. No. 4 244 840, whilst examples where solid particles are suspended are disclosed in specifications EP-A-160 342: EP-A-38 101: EP-A-104 452 and also in the aforementioned U.S. Pat. No. 4 244 840. Others are disclosed in European Patent Specification EP-A-151 884, where the lamellar droplets are called ‘spherulites’.

There are also known examples of products containing planar lamellar phases which may be extensive throughout the liquid or distributed as discrete layers interspersed with an aqueous continuous phase. Planar lamellar phases are generally less well suited to combine suspending solid material with preferred flow properties than are lamellar droplets, but they are nevertheless eminently suitable for thickening the product or endowing it with other consumer-preferred properties.

Concentrated liquid cleaning compositions are more efficient in use and require less package and transport costs per wash. However, the high concentration of ingredients is often problematic. One problem is to formulate an internally structured composition that is physically stable over a prolonged period of time as the highly concentrated surfactants tend to aggregate whereby phase seperation occurs. Moreover, because other ingredients in the composition are also present in high concentrations, these ingredients may also separate out themselves or cause other ingredients to become insoluble.

One preferred embodiment of the present invention provides a structured detergent composition comprising

(a) from 1 to 90% preferably, from 10 to 70% of an anionic, nonionic, cationic, zwitterionic active detergent material or mixtures thereof,

(b) from 1 to 60% of a salting out electrolyte;

(c) from 0.001 to 10% of protease;

(d) from 2 to 40% of at least one saccharide selected from the group consisting of disaccharides and trisaccharides, derivatives thereof and mixtures thereof;

(e) 0 to 10% of deflocculating polymer; and

(f) less than 3% of an antioxidant selected from the group consisting of alkalimetalsulphites, alkalimetalbisulphites, alkalimetabisulphites or alkalimetalthiosulphates.

The structured composition comprises less than 3 wt %, more preferably less than 2 wt %, most preferably less than 1 wt % of the antioxidant.

IIb Clarity

If the composition is lamellar structured, than the composition is preferably substantially unclear. Preferably, this means that the composition as an optical transmissivity of at less than 5% through a path length of 1 cm at 25° C. These measurements may be obtained using a Perkin Elmer UV,VIS Spectrometer Lambda 12 or a Brinkman PC801 Colorimeter at a wavelength of 520 nm, using water as the 100% standard.

IIc Surfactant

Typically, the structured compositions herein comprise from 1 to 90% by weight of an anionic, nonionic, cationic, zwitterionic active detergent material or mixtures thereof.

In the event that the structured composition is lamellar structured, the clarity of the lamellar phase may be controlled by choosing an appropriate surfactant or blend of surfactants. One suitable approach is to include aralkyl surfactants such as alkyl benzene sulphonates, i.e the total of aralkyl surfactants should more than 1%, preferably more than 5%, more preferably more than 10%, and especially more than 30% by weight of the total surfactants (including any soap).

To formulate a surfactant blend suitable for forming a lamellar phase without using aralkyl materials, one may, for example, employ a blend of primary and/or secondary alkane sulphate or sulphonate material together with one or more nonionic surfactants.

Examples of suitable alkane sulph(on)ates are sodium and potassium alkyl sulphates, especially those obtained by sulphonating higher (C₈-C₁₈), primary or secondary alcohols produced, for example, from tallow or coconut oil.

Suitable nonionic surfactants include, in particular, the reaction products of compounds having a hydrophobic group and reactive hydrogen atom, for example aliphatic alcohols, acids, amides with alkylene oxides, especially ethylene oxide, either alone or with propylene oxide. Specific nonionic detergent compounds are alkyl (C₆-C₁₈) primary or secondary linear or branched alcohols with ethylene oxide, and products made by condensation of ethylene oxide with the reaction products of propylene oxide and ethylenediamine. Other so-called nonionic detergent compounds include long chain tertiary amine oxides, long-chain tertiary phosphine oxides and dialkyl sulphoxides.

Preferably, the weight ratio at the total alkane sulph(on)ate material to the total nonionic material is from 90:10 to 10:90, more preferably from 80:20 to 50:50.

Another suitable surfactant blend for this purpose comprises one or more soaps with one or more nonionic surfactants.

Suitable soaps include alkali metal soaps of long chain mono- or dicarboxylic acids for example one having from 12 to 18 carbon atoms. Typical acids of this kind are oleic acid, ricinoleic acid and fatty acids derived from castor oil, rapeseed oil, groundnut oil, coconut oil, palm kernel oil or mixtures thereof. The sodium or potassium soaps of these acids can be used.

Suitable nonionic surfactants to blend with the soap are mentioned above. Preferably, the weight ratio of the total soap to the total nonionic material is from 60:40 to 90:10, more preferably from 70:30 to 80:20.

In other preferred structured compositions, part or all of the detergent active material is a stabilising surfactant, which has an average alkyl chain length greater then 6 C-atoms, and which has a salting out resistance, greater than, or equal to 6.4. These stabilising surfactants are disclosed in EP-A-328 177. Examples of these materials are alkyl polyalkoxylated phosphates, alkyl polyalkoxylated sulphosuccinates; dialkyl diphenyloxide disulphonates; alkyl polysaccharides and mixtures thereof. The advantage of these surfactants is that they are surfactants with a relatively low refractive index and these surfactants tend to decrease the droplet size of the lamellar droplets. Both effects have a positive effect on the clarity of the systems.

However, aside from any desire to formulate the surfactant content to control the clarity of the lamellar structured composition, in the widest sense, the detergent-active material in the structured composition, in general, may comprise one or more surfactants, and may be selected from anionic, cationic, nonionic, zwitterionic and amphoteric species, and (provided mutually compatible) mixtures thereof. For example, they may be chosen from any of the classes, sub-classes and specific materials described in ‘Surface Active Agents’ Vol.1, by Schwartz & Perry, Interscience 1949 and ‘Surface Active Agents’ vol. 11 by Schwartz, Perry & Berch (Interscience 1958), in the current edition of “McCutcheon's Emulsifiers & Detergents” published by the McCutcheon division of Manufacturing Confectioners Company or in “Tensid-Taschenbuch”, H. Stache, 2nd Edn,., Carl Hanser Verlag, München & Wien, 1981.

In many (but not all) cases, the total detergent-active material may be preferably present at from 10% to 70% by weight of the total structured composition, for example from 12% to 60% and typically from 15% to 40% by weight. However, one preferred class of structured compositions comprises at least 15%, most preferably at least 25% and especially at least 30% of detergent-active material based on the weight of the total structured composition. In the case of blends of surfactants, the precise proportions of each component which will result in such stability and viscosity will depend on the type(s) and amount(s) of the electrolytes, as is the case with conventional structured liquids.

Common anionic surfactants are usually water-soluble alkali metal salts of organic sulphates and sulphonates having alkyl radicals containing from about 8 to 22 carbon atoms, the term alkyl being used to include the alkyl portion of higher acyl radicals.

Aside from anionic surfactants already mentioned with regard to refractive index control, where appropriate, one may still employ conventional sodium and potassium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil and synthetic alcohols derived from petroleum. Other suitable anionics include sodium coconut oil fatty monoglyceride sulphates and sulphonates; sodium and potassium salts of sulphuric acid esters of higher (C₆-C₁₈) fatty alcohol-alkylene oxide, particularly ethylene oxide, reaction products; the reaction products of fatty acids such as coconut fatty acids esterified with isethionic acid and neutralised with sodium hydroxide; sodium and potassium salts of fatty acid amides of methyl taurine; alkane monosulphonates such as those derived by reacting alpha-olefins (C₈-C₂₀) with sodium bisulphite and those derived from reacting paraffins with SO₂ and Cl₂ and then hydrolyzing with a base to produce a random sulphonate; and olefin sulphonates, which term is used to describe the material made by reacting olefins, particularly C₁₀-C₂₀ alpha-olefins, with SO₃ and then neutralising and hydrolyzing the reaction product.

IId Deflocculating Polymer

In one preferred embodiment of the present invention when the composition is structured, the composition comprises from 0 to 10% of deflocculating polymer.

According to the specification of EP-A-346 995, the dependency of stability and/or viscosity upon volume fraction is favourably influenced by incorporating into the lamellar dispersion, a deflocculating polymer comprising a hydrophilic backbone and one or more hydrophobic side-chains.

The theory of function of these deflocculating polymers is that the hydrophobic chains are anchored in the outer bilayer of the lamellar droplet. The hydrophilic part is extended outwards. These hydrophilic ‘brushes’ are responsible for the steric stabilisation of the droplets, provided that the ‘brushes’ exceed a certain length. For surfactant blends in common use, the optimum length of the polymer hydrophobic chain, in order to be anchored into the bilayer is in the order of C₁₂-C₁₅, about the length of the surfactants in the droplet.

Thus, it is already well known to incorporate deflocculating polymers in aqueous liquid detergents which are structured with lamellar droplet dispersions. However, in these conventional structured compositions, the polymer is incorporated in a base composition (i.e. the same composition without the polymer) which is already stable and pourable. EP-A-346 995 defines, in practical terms, the conventional deflocculating effect as that of a polymer in a stable and pourable composition whereby the equivalent composition minus the deflocculating polymer, has a significantly higher viscosity and/or becomes unstable.

Preferably, the term “does not have significantly higher viscosity” means that a shear rate of 21 s⁻¹, the difference in viscosity is no more than 500 mpa.s, preferably no more than 250 mPa.s.

Preferably, the term “stable” means that the structured liquid detergent composition yields no more than 2% by volume visible phase separation when stored at 25° C. for 21 days from the time of preparation, more preferably less than 0.1% by volume visible phase separation when stored at 25° C. for 90 days from the time of preparation. Structured liquid detergent compositions according to the present invention are preferably “stable” according to these definitions.

Thus, when any structured composition according to the present invention comprises deflocculating polymer this may comprise one or more deflocculating polymer materials according to EP-A 346 995 and/or as recited herein below.

Generally, the amount of material of deflocculating polymer in a composition according to any aspect of the invention will be from 0.01% to 5.0% by weight in the structured composition, most preferably from 0.1% to 2.0%.

For example, EP-A-438 215 discloses preparation of acrylic acid telomers with a functional terminal group, using a secondary alcohol chain transfer agent which may, for example be a C₆-C₁₂ monofunctional secondary alcohol. These materials are described as detergent additives, in particular sequestrants or anti-precipitants. The materials are produced using polymerisation initiators such as ditertiary butyl peroxide. In the description of various different possible initiators, there is mentioned lauryl peroxide.

Some specific kinds of deflocculating polymers which contain only one hydrophobic moiety and which is attached to an end position of a hydrophilic chain, are disclosed in EP-A-623 670.

Various sub-types are described for the deflocculating polymers in EP-A-623 670. However, many of those actually exemplified are thiol polyacrylates, that is to say, materials formed by polymerisation of acrylic acid in the presence of a hydrophobic chain transfer agent having from five to twenty five carbon atoms and a terminal-SH group, in a radical polymerisation process. Analagous materials having a thia linkage between the hydrophilic and hydrophobic parts of the molecule are disclosed in US-A-5 489 395, US-A-5 489 397 and EP-A-691 399.

Another class of suitable deflocculating polymers comprises oligomers or polymers of formula (I) as disclosed in our international patent application WO-A-98/55576.

IIe Electrolyte

Although it is possible to form lamellar dispersions of surfactant in water alone, in many cases it is preferred for the aqueous continuous phase to contain dissolved electrolyte. As used herein, the term electrolyte means any ionic water-soluble material. However, in lamellar dispersions, not all the electrolyte is necessarily dissolved but may be suspended as particles of solid because the total electrolyte concentration of the liquid is higher than the solubility limit of the electrolyte. Mixtures of electrolytes also may be used, with one or more of the electrolytes being in the dissolved aqueous phase and one or more being substantially only in the suspended solid phase. Two or more electrolytes may also be distributed approximately proportionally, between these two phases. In part, this may depend on processing, e.g. the order of addition of components. On the other hand, the terms ‘salts’ includes all organic and inorganic materials which may be included, other than surfactants and water, whether or not they are ionic, and this term encompasses the sub-set of the electrolytes (water-soluble materials).

However, there is a limit to the size and amount of non-dissolved (i.e. suspended) electrolytes in these formulation which is consistent with the objective of clarity. The amount of small particles which are not visible as separate entities should be so low that the bulk of the liquid remains substantially clear in accordance with the definition of the first aspect of the present invention. The amounts of relatively large particles (i.e. visible as separate entities) should be such that they have a pleasing visual effect like the aforementioned “visible solids”.

The only restriction on the total amount of detergent-active material and electrolyte (if any) is that in the structured compositions of the invention, together they must result in formation of an aqueous lamellar dispersion. Thus, within the ambit of the present invention, a very wide variation in surfactant types and levels is possible. The selection of surfactant types and their proportions, in order to obtain a stable liquid with the required structure will be fully within the capability of those skilled in the art.

Preferably, the structured compositions contain from 1% to 60%, especially from 10 to 45% of a salting-out electrolyte. Salting-out electrolyte has the meaning ascribed to in specification EP-A-79 646. Optionally, some salting-in electrolyte (as defined in the latter specification) may also be included, provided if of a kind and in an amount compatible with the other components and the structured composition is still in accordance with the definition of the invention claimed herein. Some or all of the electrolyte (whether salting-in or salting-out), or any substantially water-insoluble salt which may be present, may have detergency builder properties. In any event, it is preferred that structured compositions according to the present invention include detergency builder material, some or all of which may be electrolyte. The builder material is any capable of reducing the level of free calcium ions in the wash liquor and will preferably provide the structured composition with other beneficial properties such as the generation of an alkaline pH, the suspension of soil removed from the fabric and the dispersion of the fabric softening clay material.

IIf Detergency Builder

As already mentioned, water soluble inorganic detergency builders (if dissolved in the aqueous phase) are electrolytes but any solid material above the solubility limit will normally be suspended by the lamellar phase.

Examples of phosphorous-containing inorganic detergency builders, when present, include the water-soluble salts, especially alkali metal pyrophosphates, orthophosphates, polyphosphates and phosphonates. Specific examples of inorganic phosphate builders include sodium and potassium tripolyphosphates, phosphates and hexametaphosphates. Phosphonate sequestrant builders may also be used.

Examples of non-phosphorous-containing inorganic detergency builders, when present, include water-soluble alkali metal carbonates, bicarbonates, silicates and crystalline and amorphous aluminosilicates. Specific examples include sodium carbonate (with or without calcite seeds), potassium carbonate, sodium and potassium bicarbonates, silicates and zeolites, although there are restrictions with respect to the amount and volume fraction of solid particles which can be added while retaining substantial clarity.

In the context of inorganic builders, we prefer to include electrolytes which promote the solubility of other electrolytes, for example use of potassium salts to promote the solubility of sodium salts. Thereby, the amount of dissolved electrolyte can be increased considerably (crystal dissolution) as described in UK patent specification GB 1 302 543.

Examples of organic detergency builders, when present, include the alkaline metal, ammonium and substituted ammonium polyacetates, carboxylates, polycarboxylates, polyacetyl carboxylates, carboxymethyloxysuccinates, carboxymethyloxymalonates, ethylene diamine-N,N-disuccinic acid salts, polyepoxysuccinates, oxydiacetates, triethylene tetramine hexa-acetic acid salts, N-alkyl imino diacetates or dipropionates, alpha sulpho-fatty acid salts, dipicolinic acid salts, oxidised polysaccharides, polyhydroxysulphonates and mixtures thereof.

Specific examples include sodium, potassium, lithium, ammonium and substituted ammonium salts of ethylenediamino-tetraacetic acid, nitrilo-triacetic acid, oxydisuccinic acid, melitic acid, benzene polycarboxylic acids and citric acid, tartrate mono succinate and tartrate di succinate.

In the context of organic builders, it is also desirable to incorporate polymers which are only partly dissolved in the aqueous continuous phase. This allows a viscosity reduction (owing to the polymer which is dissolved whilst incorporating a sufficiently high amount to achieve a secondary benefit, especially building, because the part which is not dissolved does not bring about the instability that would occur if substantially all were dissolved). As for inorganic builders, the same restrictions apply with respect to the amount and volume fraction of non-dissolved polymer phase which can be added while retaining substantial clarity.

IIg Other Polymers

Examples of partly dissolved polymers include many of the polymer and co-polymer salts already known as detergency builders. For example, may be used (including building and non-building polymers) polyethylene glycols, polyacrylates, polymaleates, polysugars, polysugarsulphonates and co-polymers of any of these. Preferably, the partly dissolved polymer comprises a co-polymer which includes an alkali metal salt of a polyacrylic, polymethacrylic or maleic acid or anhydride. Preferably, structured compositions with these co-polymers have a pH of above 8.0. In general, the amount of viscosity-reducing polymer can vary widely according to the formulation of the rest of the structured composition. However, typical amounts are from 0.5 to 4.5% by weight.

It is further possible to include in the structured compositions of the present invention, alternatively, or in addition to the partly dissolved polymer, yet another polymer which is substantially totally soluble in the aqueous phase and has an electrolyte resistance of more than 5 grams sodium nitrilotriacetate in 100 ml of a 5% by weight aqueous solution of the polymer, said second polymer also having a vapour pressure in 20% aqueous solution, equal or less than the vapour pressure of a reference 2% by weight or greater aqueous solution of polyethylene glycol having an average molecular weight of 6,000; said second polymer having a molecular weight of at least 1,000.

The incorporation of the soluble polymer permits formulation with improved stability at the same viscosity (relative to the structured composition without the soluble polymer) or lower viscosity with the same stability. The soluble polymer can also reduce viscosity drift, even when it also brings about a viscosity reduction. Here, improved stability and lower viscosity mean over and above any such effects brought about by the deflocculating polymer.

It is especially preferred to incorporate the soluble polymer with a partly dissolved polymer which has a large insoluble component. That is because although the building capacity of the partly dissolved polymer will be good (since relatively high quantities can be stably incorporated), the viscosity reduction will not be optimum (since little will be dissolved). Thus, the soluble polymer can usefully function to reduce the viscosity further, to an ideal level.

The soluble polymer can, for example, be incorporated at from 0.05 to 20% by weight, although usually from 0.1 to 10% by weight of the total structured composition is sufficient, and especially from 0.2 to 3.5-4.5% by weight. It has been found that the presence of deflocculating polymer increase the tolerance for higher levels of soluble polymer without stability problems. A large number of different polymers may be used as such a soluble polymer, provided the electrolyte resistance and vapour pressure requirements are met. The former is measured as the amount of sodium nitrolotriacetate (NaNTA) solution necessary to reach the cloud point of 100 ml of a 5% w/w solution of the polymer in water at 25° C., with the system adjusted to neutral pH, i.e. about 7. This is preferably effected using sodium hydroxide. Most preferably, the electrolyte resistance is 10 g NaNTA, especially 15 g. The latter indicates a vapour pressure low enough to have sufficient water binding capability, as generally explained in the applicants' specification GB-A-2 053 249. Preferably, the measurement is effected with a reference solution at 10% by weight aqueous concentration, especially 18%.

Typical classes of polymers which may be used as the soluble polymer, provided they meet the above requirements, include polyethylene glycols, Dextran, Dextran sulphonates, polyacrylates and polyacrylate/maleic acid co-polymers.

The soluble polymer must have an average molecular weight of at least 1,000 but a minimum average molecular weight of 2,000 is preferred.

The use of partly soluble and the use of soluble polymers as referred to above in detergent compositions is described in our European patent specifications EP-A-301 882 and EP-A-301 883.

IIh Hydrotropes

Although it is possible to incorporate minor amounts of hydrotropes such as lower alcohols (e.g. ethanol) or alkanolamines (e.g. triethanolamine), in order to ensure integrity of the lamellar dispersion we prefer that the structured compositions of the present invention are substantially free from hydrotropes. By hydrotrope is meant any water soluble agent which tends to enhance the solubility of surfactants in aqueous solution.

III Liquid Detergents in General

The liquid detergent composition according the invention being either isotropic or structured may contain additional optional ingredients.

Enzymes

“Detersive enzyme”, as used herein, means any enzyme having a cleaning, stain removing or otherwise beneficial effect in a laundry application. Enzymes are included in the present detergent compositions for a variety of purposes, including removal of protein-based, saccharide-based, or triglyceride-based stains, for the prevention of refugee dye transfer, and for fabric restoration. Suitable enzymes include proteases, amylases, lipases, cellulases, peroxidases, and mixtures thereof of any suitable origin, such as vegetable, animal, bacterial, fungal and yeast origin. Preferred selections are influenced by factors such as pH-activity and/or stability optima, thermostability, and stability to active detergents, builders and the like. In this respect bacterial or fungal enzymes are preferred, such as bacterial amylases and proteases, and fungal cellulases.

Enzymes are normally incorporated into detergent or detergent additive compositions at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics. In practical terms for current commercial preparations, typical amounts are up to about 5 mg by weight, more typically 0.01 mg to 3 mg, of active enzyme per gram of the detergent composition. Stated otherwise, the compositions herein will typically comprise from 0.0001% to 10%, preferably from 0.001% to 5%, more preferably 0.005%-1% by weight of a commercial enzyme preparation.

The Proteolvte Enzyme

Endopeptidases (proteolytic enzymes or proteases) of various qualities and origins and having activity in various pH ranges of from 4-12 are available and can be used in the instant invention. Examples of suitable proteolytic enzymes are the subtilisins, which can be obtained from particular strains of B. subtilis, B. lentus, B. amyloliquefaciens and B. licheniformis, such as the commercially available subtilisins Savinase™, Alcalase™, Relase™, Kannase™ and Everlase™ as supplied by Novo Industri A/S, Copenhagen, Denmark or Purafect™, PurafectOxpυ and Properase™ as supplied by Genencor International. Chemically or genetically modified variants of these enzymes are included such as described in WO-A-99/02632 pages 12 to 16 and in WO-A-99/20727 and also variants with reduced allergenicity as described in WO-A-99/00489 and WO-A-99/49056.

It should be understood that the protease is present in the liquid detergent composition in a dissolved or dispersed form, i.e., the protease is not encapsulated to prevent the protease from the liquid composition. Instead the protease in more or less in direct contact with the liquid composition.

Suitable examples of proteases are the subtilisins which are obtained from particular strains of B. subtilis and B. licheniformis. One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB 1,243,784 to Novo. Other suitable proteases include ALCALASE™ and SAVINASE™ from Novo and MAXATASE™ from International Bio-Synthetics, Inc., The Netherlands; as well as Protease A as disclosed in EP 130,756 A, and Protease B as disclosed in EP 303,761 A and EP 130,756 A. See also a high pH protease from Bacillus sp. NCIMB 40338 described in WO 9318140 A to Novo. Enzymatic detergents comprising protease, one or more other enzymes, and a reversible protease inhibitor are described in WO 9203529 A. Other preferred proteases include those of WO 9510591 A. When desired, a protease having decreased adsorption and increased hydrolysis is available as described in WO 9507791. A recombinant trypsin-like protease for detergents suitable herein is described in WO 9425583.

Useful proteases are also described in PCT publications: WO 95/30010, WO 95/30011, WO 95/29979.

Preferred proteolytic enzymes are also modified bacterial serine proteases, such as those described in EP-A-251446 (particularly pages 17, 24 and 98), and which is called herein “Protease B”, and in EP-A-199404, which refers to a modified bacterial serine proteolytic enzyme which is called “Protease A” herein, Protease A as disclosed in EP-A-130756.

The preferred liquid laundry detergent compositions according to the present invention comprise at least 0.001% by weight, of a protease enzyme. However, an effective amount of protease enzyme is sufficient for use in the liquid laundry detergent compositions described herein. The term “an effective amount” refers to any amount capable of producing a cleaning, stain removal, soil removal, whitening, deodorizing, or freshness improving effect on substrates such as fabrics. In practical terms for current commercial preparations, typical amounts are up to about 5 mg by weight, more typically 0.001 mg to 3 mg, of active enzyme per gram of the detergent composition. Stated otherwise, the compositions herein will typically comprise from 0.001% to 5%, preferably 0.01%-1% by weight of a commercial enzyme preparation. Typically, the proteolytic enzyme content is up to 0.2%, preferably from 4×10⁻⁵% to 0.06% by weight of the composition of pure enzyme.

Other Enzymes

The compositions of the invention may optionally contain one or more other enzymes. For example, they may contain 10-20,000 LU per gram of the detergent composition of a lipolytic enzyme selected from the group consisting of Lipolase, Lipolase ultra, LipoPrime, Lipomax, Liposam, and lipase from Rhizomucor miehei (e.g. as described in EP-A-238 023 (Novo Nordisk).

The enzymatic detergent compositions of the invention further comprise 10-20,000 LU per gram, and preferably 50-2,000 LU per gram of the detergent composition, of an lipolytic enzyme. In this specification LU or lipase units are defined as they are in EP-A-258 068 (Novo Nordisk).

A further method of assessing the enzymatic activity is by measuring the reflectance at 460 nm according to standard techniques.

Suitable other enzymes for use in the compositions of the invention can be found in the enzyme classes of the esterases and lipases, (EC 3.1.1.*, wherein the asterisk denotes any number).

A characteristic feature of lipases is that they exhibit interfacial activation. This means that the enzyme activity is much higher on a substrate which has formed interfaces or micelles, than on fully dissolved substrate. Interface activation is reflected in a sudden increase in lipolytic activity when the substrate concentration is raised above the critical micel concentration (CMC) of the substrate, and interfaces are formed. Experimentally this phenomenon can be observed as a discontinuity in the graph of enzyme activity versus substrate concentration. Contrary to lipases, however, cutinases do not exhibit any substantial interfacial activation.

Suitable lipase enzymes for detergent usage include those produced by microorganisms of the Pseudomonas group, such as Pseudomonas stutzeri ATCC 19.154, as disclosed in GB 1,372,034. See also lipases in Japanese Patent Application 53,20487. This lipase is available from Amano Pharmaceutical Co. Ltd., Nagoya, Japan, under the trade name Lipase P “Amano,” or “Amano-P.” Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. LIPOLASE™ enzyme derived from Humicola lanyginosa and commercially available from Novo, see also EP 341,947, is a preferred lipase for use herein. Lipase and amylase variants stabilized against peroxidase enzymes are described in WO 9414951 A to Novo. See also WO 9205249. Cutinase enzymes suitable for use herein are described in WO 8809367 A to Genencor.

Because of this characteristic feature, i.e. the absence of interfacial activation, we define for the purpose of this patent application Cutinases as lipolytic enzymes which exhibit substantially no interfacial activation. Cutinases therefor differ from classical lipases in that they do not possess a helical lid covering the catalytic binding site. Cutinases belong to a different subclass of enzymes (EC 3.1.1.50) and are regarded to be outside the scope of the present invention.

Of main interest for the present invention are fungal lipases, such as those from Humicola lanuginosa and Rhizomucor miehei. Particularly suitable for the present invention is the lipase from Humicola lanuginosa strain DSM 4109, which is described in EP-A-305 216 (Novo Nordisk), and which is commercially available as Lipolase (™). Also suitable ar variants of this enzyme, such as described in WO-A-92/05249, WO-A-94/25577, WO-A-95/22615, WO-A-97/04079, WO-A-97/07202, WO-A-99/42566, WO-A-00/60063. Especially preferred is the variant D96L which is commercially available from Novozymes as Lipolase ultra, and the variant which is sold by Novozymes under the trade name LipoPrime.

The lipolytic enzyme of the present invention can usefully be added to the detergent composition in any suitable form, i.e. the form of a granular composition, a slurry of the enzyme, or with carrier material (e.g. as in EP-A-258 068 and the Savinase (™) and Lipolase (™) products of Novozymes). A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

The enzyme to be used in the detergent compositions according to the invention can be produced by cloning the gene for the enzyme into a suitable production organism, such as Bacilli, or Pseudomonaceae, yeasts, such as Saccharomyces, Kluyveromyces, Hansenula or Pichia, or fungi like Aspergillus. The preferred production organism is Aspergillus with especial preference for Aspergillus oryzae.

Other optional suitable enzymes which may be included alone or in combination with any other enzyme may, for example, be oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press. The most recent information on the nomenclature of enzymes is available on the Internet through the ExPASy WWW server (http://www.expasy.ch/).

Examples of the hydrolases are carboxylic ester hydrolase, thiolester hydrolase, phosphoric monoester hydrolase, and phosphoric diester hydrolase which act on the ester bond; glycosidase which acts on O-glycosyl compounds; glycosylase hydrolysing N-glycosyl compounds; thioether hydrolase which acts on the ether bond; and exopeptidases and endopeptidases which act on the peptide bond. Preferable among them are carboxylic ester hydrolase, glycosidase and exo- and endopeptidases. Specific examples of suitable hydrolases include (1) exopeptidases such as aminopeptidase and carboxypeptidase A and B and endopeptidases such as pepsin, pepsin B, chymosin, trypsin, chymotrypsin, elastase, enteropeptidase, cathepsin B, papain, chymopapain, ficain, thrombin, plasmin, renin, subtilisin, aspergillopepsin, collagenase, clostripain, kallikrein, gastricsin, cathepsin D, bromelain, chymotrypsin C, urokinase, cucumisin, oryzin, proteinase K, thermomycolin, thermitase, lactocepin, thermolysin, bacillolysin. Preferred among them is subtilisin; (2) glycosidases such as αamylase, β-amylase, glucoamylase, isoamylase, cellulase, endo-1,3(4)-β-glucanase (β-glucanase), xylanase, dextranase, polygalacturonase (pectinase), lysozyme, invertase, hyaluronidase, pullulanase, neopullulanase, chitinase, arabinosidase, exocellobiohydrolase, hexosaminidase, mycodextranase, endo-1,4-β-mannanase (hemicellulase), xyloglucanase, endo-β-galactosidase (keratanase), mannanase and other saccharide gum degrading enzymes as described in WO-A-99/09127. Preferred among them are α-amylase and cellulase; (3) carboxylic ester hydrolase including carboxylesterase, lipase, phospholipase, pectinesterase, cholesterol esterase, chlorophyllase, tannase and wax-ester hydrolase.

Examples of transferases and ligases are glutathione S-transferase and acid-thiol ligase as described in WO-A-98/59028 and xyloglycan endotransglycosylase as described in WO-A-98/38288.

Examples of lyases are hyaluronate lyase, pectate lyase, chondroitinase, pectin lyase, alginase II. Especially preferred is pectolyase, which is a mixture of pectinase and pectin lyase.

Examples of the oxidoreductases are oxidases such as glucose oxidase, methanol oxidase, bilirubin oxidase, catechol oxidase, laccase, peroxidases such as ligninase and those described in WO-A-97/31090, monooxygenase, dioxygenase such as lipoxygenase and other oxygenases as described in WO-A-99/02632, WO-A-99/02638, WO-A-99/02639 and the cytochrome based enzymatic bleaching systems described in WO-A-99/02641.

Peroxidase enzymes may be used in combination with oxygen sources, e.g., percarbonate, perborate, hydrogen peroxide, etc., for “solution bleaching” or prevention of transfer of dyes or pigments removed from substrates during the wash to other substrates present in the wash solution. Known peroxidases include horseradish peroxidase, ligninase, and haloperoxidases such as chloro- or bromo-peroxidase.

Peroxidase-containing detergent compositions are disclosed in WO 89099813 A, Oct. 19, 1989 to Novo and WO 8909813 A to Novo.

A range of enzyme materials and means for their incorporation into synthetic detergent compositions is also disclosed in WO 9307263 A and WO 9307260 A to Genencor International, WO 8908694 A to Novo, and U.S. Pat. No. 3,553,139, Jan. 5, 1971 to McCarty et al.

A process for enhancing the efficacy of the bleaching action of oxidoreductases is by targeting them to stains by using antibodies or antibody fragments as described in WO-A-98/56885. Antibodies can also be added to control enzyme activity as described in WO-A-98/06812.

A preferred combination is a detergent composition comprising of a mixture of the protease of the invention and conventional detergent enzymes such as lipose, amylase and/or cellulase together with one or more plant cell wall degrading enzymes.

Suitable amylases include those of bacterial or fungal origin. Chemically or genetically modified variants of these enzymes are included as described in WO-A-99/02632 pages 18, 19. Commercial cellulase are sold under the tradename Purastar™, Purastar OxAm™ (formerly Purafact OxAm™) by Genencor; Termamyl™, Fungamyl™, Duramyl™, Natalase™, all available from Novozymes.

Amylases suitable herein include, for example, alfa-amylases described in GB 1,296,839 to Novo; RAPIDASE™, International Bio-Synthetics, Inc. and TERMAMYL™, Novo. FUNGAMYL™ from Novo is especially useful.

See, for example, references disclosed in WO 9402597. Stability-enhanced amylases can be obtained from Novo or from Genencor International. One class of highly preferred amylases herein have the commonality of being derived using site-directed mutagenesis from one or more of the Baccillus amylases, especialy the Bacillus cc-amylases, regardless of whether one, two or multiple amylase strains are the immediate precursors.

Oxidative stability-enhanced amylases vs. the above-identified reference amylase are preferred for use, especially in bleaching, more preferably oxygen bleaching, as distinct from chlorine bleaching, detergent compositions herein. Such preferred amylases include (a) an amylase according to WO 9402597, known as TERMAMYL™.

Particularly preferred amylases herein include amylase variants having additional modification in the immediate parent as described in WO 9510603 A and are available from the assignee, Novo, as DURAMYL™. Other particularly preferred oxidative stability enhanced amylase include those described in WO 9418314 to Genencor International and WO 9402597 to Novo Or WO 9509909 A to Novo.

Suitable cellulases include those of bacterial or fungal origin. Chemically or genetically modified variants of these enzymes are included as described in WO-A-99/02632 page 17. Particularly useful cellulases are the endoglucanases such as the EGIII from Trichoderrna longibrachiatum as described in WO-A-94/21801 and the E5 from Thermomonospora fusca as described in WO-A-97/20025. Endoglucanases may consist of a catalytic domain and a cellulose binding domain or a catalytic domain only. Preferred cellulolytic enzymes are sold under the tradename Carezyme™, Celluzyme™ and Endolase™ by Novo Nordisk A/S; Puradax™ is sold by Genencor and KAC™ is sold by Kao corporation, Japan.

Cellulases usable herein include both bacterial and fungal types, preferably having a pH optimum between 5 and 9.5. U.S. Pat. No. 4,435,307 discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A-2.095.275 and DE-OS-2.247.832. CAREZYME™ (Novo) is especially useful. See also WO 9117243.

Detergent enzymes are usually incorporated in an amount of 0.00001% to 2%, and more preferably 0.001% to 0.5%, and even more preferably 0.005% to 0.2% in terms of pure enzyme protein by weight of the composition. Detergent enzymes are commonly employed in the form of granules made of crude enzyme alone or in combination with other components in the detergent composition. Granules of crude enzyme are used in such an amount that the pure enzyme is 0.001 to 50 weight percent in the granules. The granules are used in an amount of 0.002 to 20 and preferably 0.1 to 3 weight percent. Granular forms of detergent enzymes are known as Enzoguard™ granules, prills, marumes or T-granules. Granules can be formulated so as to contain an enzyme protecting agent (e.g. oxidation scavengers) and/or a dissolution retardant material. Other suitable forms of enzymes are liquid forms such as the “L” type liquids from Novo Nordisk, slurries of enzymes in nonionic surfactants such as the “SL” type sold by Novo Nordisk and microencapsulated enzymes marketed by Novo Nordisk under the tradename “LDP” and “CC”.

The enzymes can be added as separate single ingredients (prills, granulates, stabilised liquids, etc. containing one enzyme) or as mixtures of two or more enzymes (e.g. cogranulates). Enzymes in liquid detergents can be stabilised by various techniques as for example disclosed in US-A-4 261 868 and US-A-4 318 818.

The detergent compositions of the present invention may additionally comprise one or more biologically active peptides such as swollenin proteins, expansins, bacteriocins and peptides capable of binding to stains.

Other Enzyme Stabilisers

In addition to the polyoxometalate, optionally, compositions of the invention may contain one or more other enzyme stabilisers.

Any additional enzyme stabiliser may be selected from boron-containing protease enzyme stabilisers, non-boron protease enzyme stabilisers and mixtures thereof.

Boron-Containing Enzyme Stabilisers

Typical boron-based stabilisers include boron-based reversible stabilisers which comprise a boron compound and another substance capable of complexing with the boron compound to stabilise the enzyme in the composition but which complexes dissociate in the wash liquor to render the enzyme active.

Suitable boron compounds include sodium metaborate or sodium tetraborate (borax).

Typical substances which form a reversible complex with the boron compound including polyols such as glycerol, propylene glycol, and sorbitol. However, these are not enzyme stabilisers in the absence of the boron compound.

Typical inorganic boron sources are derivatives of boric acid including boric oxide, polyborates, orthoborates and metaborates or mixtures thereof. Preferred compounds are the alkali salts of the boric acid derivatives, such as sodium borate and borax. Typical organic boron stabilisers are aromatic borate esters and boronic acid derivatives, such as alkyl, aryl and peptide boronic acids. Boronic acids are well-known as reversible inhibitors for subtilisine type of proteases.

Another boron-based stabilising system which may be used is the combination of boric acid or a boron compound capable of forming boric acid in the composition and a source of calcium ions, such as disclosed in EP-A-0 199 405.

Non-Boron Enzyme Stabilisers

Non-boron enzyme stabilisers include water soluble calcium compounds such as calcium chloride and/or formate and water soluble short chain carboxylic acids, as well as sources of chlorine scavenge ions such as ammonium sulphates, bisulphites, thiosulphites, thiosulphate and thiols.

Mixtures of one or more boron- and or non-boron enzyme stabilisers may also be based.

The total amount of enzyme stabiliser or stabiliser system is typically from 0.001% to 10%, preferably from 0.005% to 7.5%, especially from 0.01% to 5% by weight of the total composition.

Many non-boron stabilisers are protein inhibitors from various sources and modified peptides (such as peptide aldehydes and peptide trifluoromethyl ketones). Suitable examples of these and other non-boron stabilisers include the following:

WO-A-00/01 826 discloses stabilized variants of Streptomycin subtilisin inhibitor (protein inhibitor+variants).

WO-A-98/13459 discloses liquid detergents containing proteolytic enzyme, peptide aldehydes and calcium ions.

EP-A-0 583 534 discloses liquid detergents containing a peptide aldehyde .

EP-A-0 583 535 describes liquid detergents containing a peptide trifluoromethylketone.

WO-A-97/00392 describes enzymatic compositions with improved storage stability of the enzymes contained therein are obtained by including an enzyme stabiliser, preferably by way of a particular process concerns the use of lignosulphonates.

WO-A-00/01831 describes a fusion between a subtilisin and streptomyces inhibiors variants).

Another suitable class of non-boron enzyme stabiliser comprises the reversible protease inhibitors of peptide or protein type, e.g. as disclosed in W092/03529.

Further, our unpublished European Patent Application NO. 00202092.3 discloses other suitable non-boron enzyme stabilisers comprising at least one saccharide selected from disaccharides, trisaccharides and derivatives of either as well as mixtures of these disaccharides, trisaccharides and derivatives.

Yet others are disclosed in WO-A-98/13458, WO-A-98/13460, WO-A-98/13461, US-A-5,178,198, W092/03529, WO-A-93/20175 and US-A-5,156,773.

Further non-boron compounds which may be incorporated as compounds which are capable of stabilising proteases in liquids are organic substances which form complexes with a transition metal, the complex being capable of catalysing bleaching of a substrate by atmospheric oxygen. Such compounds may be used as the free ligand and/or in complex with a transition metal, e.g. as disclosed in WO-A-00/12677. One specific ligand of this kind is N,N-bis (pyridin-2-yl-methyl)-1,1-bis (pyridin-2-yl)-1-aminoethane. Yet other suitable non-boron protease stabilisers are ascorbic acid and its salts.

The Polyoxometalate

A polyoxometalate is an essential feature of the present invention. Polyoxometalates are inorganic complexes which are transition metal-oxygen-anion clusters. They have defined oligomeric or polymeric structural units which form spontaneously under appropriate conditions in an aqueous medium from simple compounds of vanadium, niobium, tantalum, molybdenum or tungsten. The polyoxometalates are subdivided into isopoly- and heteropolyoxometalates. (see M. T. Pope. Heteropoly and Isopoly Oxometalates, Springer-Verlag, Berlin, 1983).

The amount of polyoxometalate may be from 0.001% to 10% preferably from 0.005% to 7.5%, more preferably from, 0.05% to 2.5% by weight of polyoxometalate.

Isopolyoxometalates are the simpler of the forms. They can be described as binary, i.e. containing only metal ion and oxygen, oxide anions of the formula [MₘO_{y}]^{p-}. Typical examples are [Mo₂O₇]²⁻, [WO₇O₂₄]⁶⁻, [Mo₆O₁₉]²⁻ and [Mo₃₆O₁₁₂]⁸⁻.

In contrast, heteropolyoxometalates also contain further non-metal, semi-metal and/or transition metal ions. Heteropolyoxometalates of the general form [XₓAₐMₘO_{y}]^{p-}, where X is a nonmetal or semi-metal ion or non-transition metal ion or inorganic compound ion and A is a transition metal ion, possess one or more so-called heteroatoms X and/or A. One example is [PW₁₂O₄₀]³⁻ (where X═P). By substitution of MₘO_{y} structural units in both isopoly- and heteropolyoxometalates for a transition metal ion A it is possible to introduce redoxidative transition metal ions of type A into the solid structures. Known examples include transition metal-doped, so-called Keggin anions of the formula [APW₁₁O₃₉]^{7-/18-} where A═Zn, Co, Ni, Mn (J. Amer. Chem. Soc., 113, page 7209, 1991) and Dawson anions [AP₂W₁₇O₆₁]^{7-/18-} where A=Mn, Fe, Co, Ni, Cu (J. Amer. Chem. Soc. 109, page 402, 1987), which may also contain bound water of crystallization. Further substitutions, including different transition metal ions, are known, for example [WZnMn₂(ZnW₉O₃₄)¹²− (J. Amer. Chem. Soc. 116, page 5509, 1994). The charge of the above-described anions are compensated by protons (thereby giving the corresponding poly acids) or by cations (formation of poly-acid salts=heteropolyoxometalates).

For simplicity, the term polyoxometallate as used in the description embraces not only the salts of the polyacids but also the corresponding poly acids themselves.

The bleaching catalysts used in accordance with the invention preferably have the formula (I)

(Q)_{q}(AₐXₓMₘO_{y}Z_{z}(H₂O)_{b})cH₂O (I)

where Q, A, X, M, Z, q, a, x, m, y, z, b and c are defined as follows:

Q is one or more cations selected from the group consisting of H, Li, K, Na, Rb, Cs, Ca, Mg, Sr, Ba, Al, PR¹R²R³R⁴ and NR¹R²R³R⁴, in which R¹, R², R³ and R⁴ are identical or different and are H, C₁-C₂₀-alkyl, C₅-C8-cycloalkyl or C₆-C₂₄-aryl;

q is a number from 1 to 60, in particular from 1 to 40, and for monovalent countercations simultaneously describes the charge of the anionic unit;

A is one or more transition metals from subgroups 2 to 8, preferably Mn, Ru, V, Ti, Zr, Cr, Fe, Co, Zn, Ni, Re and Os, particularly preferably Mn, Ru, V, Ti, Fe, Co and Zn;

a is a number from 0 to 10, preferably from 0 to 8;

X is one or more atoms selected from the group consisting of Sb, S, Se, Te, Bi, Ga, B, P, Si, Ge, F, Cl, Br and I, preferably P, B, S, Sb, Bi, Si, F, Cl, Br and I;

x is a number from 0 to 10, preferably 0 to 8;

M is one or more transition metals selected from the group consisting of Mo, W, Nb, Ta and V;

m is a number from 0.5 to 60, preferably 4 to 10;

Z is one or more anions selected from the group consisting of OH⁻, F⁻, Cl⁻, Br⁻, I⁻, N₃⁻, NO₃⁻, ClO₄⁻, NCS⁻, SCN⁻, PF₆⁻, RSO₃⁻, RSO₄⁻, CF₃SO₃⁻, BR₄⁻, BF₄⁻, CH₃COO⁻ where R is H, C₁-C₂₀-alkyl, C₅-C₈-cycloalkyl or C₆-C₂₄-aryl;

z is a number from 0 to 10, preferably from 0 to 8;

O is oxygen;

y is the number of oxygen atoms required for structure/charge compensation, and

b and c independently of one another are numbers from 0 to 50, preferably from 0 to 30.

In the above formula q, a, x, m, y, z, b and c are preferably integers in their respective ranges.

Particular preference is given to the following polyoxometalates:

Q₅Co(III)W₁₂I₄₀ (Q=K, Na, NMe, NBu, or a mixture of these)

K₅Mn(III)SiW₁₁O₃₉

(Me₃NH)₄(NbO₂)PW₁₁O₃₉

Na₆Co(III)AlW₁₁O₄₀H₂

K₁₀[βCu₃SiW₉O₄₀H₃]

K₉[P₂V₃W₁₇O₆₂H₂]

Na₁₂[WMn₂(H₂O)₂(ZnW₉O₃₄)₂]

Na₁₆[Cu₄(H₂O)₂(P₂W₁₅O₅₆)₂]

Na₁₀[Mn₄(H₂O)₂(PW₉O₃₄)₂]

(NH₄)₁₄[NaP₅W₃O₁₀₀]*

(Me₃NH)₄(NbO₂)PW₁₁O₃₉

*=containing water of crystallization and mixtures thereof.

Table I lists a variety of typical polyoxometalates which have been synthesised which may be utilised in the present invention.

TABLE I

| | POM Sub- | | | |
|---|---|---|---|---|
| POM Class | Class | POM Formula | Hetero* | Homo** |
| Keggin | Keggin | H₃PW₁₂O₄₀ | X | X |
| | | H₄SiW₁₂O₄₀ | X | X |
| | | K₆Co(II)W₁₂O₄₀ | X | |
| | | K₅Co(III)W₁₂O₄₀ | X | |
| | Lacunary | K₇PW₁₁O₄₀ | X | X |
| | | K₈SiW₁₁O₃₉ | X | X |
| | | K₈SiW₁₀O₃₆ | X | X |
| | | α-Na₁₀SiW₉O₃₄ | X | X |
| | Mono-TMSP | K₆Mn(II)SiW₁₁O₃₉ | X | X |
| | | K₅Mn(III)SiW₁₁O₃₉ | X | X |
| | | K₆Co(II)SiW₁₁O₃₉ | X | X |
| | | K₅Co(III)SiW₁₁O₃₉ | X | X |
| | | K₅Fe(III)SiW₁₁O₃₉ | X | X |
| | | K₆Cu(II)SiW₁₁O₃₉ | X | X |
| | | K₅Mn(II)PW₁₁O₃₉ | X | X |
| | | K₄Mn(III)PW₁₁O₃₉ | X | X |
| | | K₅Co(II)PW₁₁O₃₉ | X | X |
| | | K₄Co(III)PW₁₁O₃₉ | X | X |
| | | K₄Fe(III)PW₁₁O₃₉ | X | X |
| | | K₆Cu(II) PW₁₁O₃₉ | X | X |
| | | K₅(NbO₂)SiW₁₁O₃₉ | X | |
| | | Cs₅(NbO₂)SiW₁₁O₃₉ | X | |
| | | Cs₅NbSiW₁₁O₄₀ | X | |
| | | (Me₃NH₄(NbO₂)PW₁₁O₃₉ | X | |
| | | K₅VSiW₁₁O₄₀ | X | X |
| | | K₇Mn(II)AIW₁₁O₄₀H₂ | X | X |
| | | Na₆Mn(III)AIW₁₁O₄₀H₂ | X | X |
| | | Na₆Co(III)AIW₁₁O₄₀H₂ | X | X |
| | | K₆CoAIW₁₁O₄₀ | | X |
| | | K₆VAIW₁₁O₄₀ | | X |
| | | Na₆VAIW₁₁O₄₀ | X | X |
| | | K₆MnBW₁₁O₄₀H₂ | X | |
| | | K₇VZnW₁₁O₄₀ | | X |
| | | K₈V(IV)Co(II)W₁₁O₄₀ | X | |
| | Di-TMSP | K₆V₂SiW₁₀O₄₀ | X | X |
| | | K₇VMnSiW₁₀O₃₉ | X | X |
| | | K₇VCoSiW₁₀O₃₉ | X | X |
| | | K₆VNbSiW₁₀O₄₀ | X | X |
| | | H₅PV₂Mo₁₀O₄₀ | X | |
| | | TBA₅PV₂Mo₁₀O₄₀ | X | |
| | | Cs₅PV₂W₁₀O₄₀ | X | |
| | | K₄[SiMn₂W₁₀O₄₀H₆] | X | |
| | Tri-TMSP | K₇V3SiW₉O₄₀ | X | X |
| | | H₇V₃SiW₉O₄₀ | X | X |
| | | K₇Mo₂VSiW₉O₅₀ | X | X |
| | | K₆V₃PW₉O₃₉ | X | |
| | | Cs₇(NbO₂)₃SiW₉O₃₇ | X | |
| | | Cs₆(NbO₂)₃PW₉O₃₇ | X | |
| | | K₁₀[β-Cu₃SiW₉O₄₀H₃] | X | |
| | | K₅H₅[α-Cu₃SiW₉O₄₀H₃] | X | |
| Dawson | Dawson | K₆[α-P₂W₁₈O₆₂] | X | X |
| | | K₆[β-P₂W₁₈O₆₂] | X | |
| | Lacunary | K₉[α2-P₂W₁₇O₆₁] | X | |
| | | K₉[α₁-LiP₂W₁₇O₆₁] | X | |
| | | Na₁₂[α-P₂W₁₅O₅₆] | X | |
| | Mono-TMSP | K₈[P₂CuW₁₇O₆₂H₂] | X | X |
| | | K₈[P₂Mn(II)W₁₇O₆₂H₂] | X | |
| | Tri-TMSP | K₉[P₂V₃W₁₇O₆₂H₂] | X | X |
| Sandwich | Keggin | Na₁₀[Mn₄(H₂O)₂(PW₉O₃₄)₂] | | |
| | | Na₁₀[Co₄(H₂O)₂(PW₉O₃₄)₂] | | |
| | | Na₁₀[Cu₄(H₂O)₂(PW₉O₃₄)₂] | | |
| | | Na₁₂[WMn₂(H₂O)₂(ZnW₉O₃₄)₂] | | |
| | | Na₁₂[WCo₂(H₂O)₂(ZnW₉O₃₄)₂] | | |
| | | Na₁₂[WCu₂(H₂O)₂(ZnW₉O₃₄)₂] | | |
| | Dawson | Na₁₆[Cu₄(H₂O)₂(P₂W₁₅O₅₆)₂] | X | |
| | | Na₁₂[Fe₄(H₂O)₂(P₂W₁₅O₅₆)₂] | | X |
| | Pressyler | (NH₄)₁₄[NaP₅W₃₀O₁₁₀].31H₂O | X | |

*“Hetero” refers to a heterogeneous protocol;
**“Homo” refers to a homogeneous protocol; using stain mimic dye molecules (such as Red Acid 88) in a homogeneous medium.

Bleaches

Optionally, any composition according to the invention may contain a bleach or bleach system.

Preferred are the oxygen bleaches and oxygen bleach systems, for example in the form of an inorganic persalt preferably with an activator, or as a peroxy acid compound.

In the case of the inorganic persalt bleaches, the activator makes the bleaching more effective at lower temperatures, i.e. in the range from ambient temperature to about 60° C., so that such bleach systems are commonly known as low-temperature bleach systems and are well known in the art. The inorganic persalt such as sodium perborate, both the monohydrate and the tetrahydrate, acts as release active oxygen n solution, and activator is usually an organic compound having one or more reactive acyl residues, which cause the formation of peracids, the latter providing for more effective bleaching action at lower temperatures than the peroxy-bleach compound alone. The ratio by weight of the peroxy bleach compound to the activator is from about 15:1 to about 2:1, preferably from about 10:1 to about 3.5:1. Whilst the amount of the bleach system, i.e. peroxy bleach compounds and activator may be varied between about 5% and about 35% by weight of the total liquid, it is preferred to use from about 6% to about 30% of the ingredients forming the bleach system. Thus, the preferred level of the peroxy bleach compound in the composition is between 5.5% and about 27% by weight, while the preferred level of the activator is between about 0.5% and about 40%, most preferably between about 1% and about 5% by weight.

Typical examples of the suitable peroxybleach compounds are alkalimetal perborates, both tetrahdyrates and monohydrates, alkali metal, percarbonates, alkylhydroperoxides such as cumene hydroperoxide and t-butyl hydroperoxide, persilicates and perphosphates, of which sodium perborate is preferred. Activators for peroxybleach compounds have been amply described in the literature, including in British patent specifications 836988, 855735, 907356, 907358, 907950, 1003310 and 1246339, U.S. Pat. Nos. 3,332,882 and 4,128,494, Canadian patent specification 844481 and South African patent specification 68/6344.

The exact mode of action of such activators is not known, but it is believed that peracids are formed by reaction of the activators with the inorganic peroxy compound, which peracids then liberate active-oxygen by decomposition.

They are generally compounds which contain N-acyl or O-acyl residues in the molecule and which exert their activating action on the peroxy compounds on contact with these in the washing liquor.

Typical examples of activators within these groups are polyacylated alkylene diamines, such N,N,N¹N¹⁻-tetraacetylethylene diamine (TAED) and N,N,N¹,N¹⁻-tetraacetylmethylene diamine (TAMD); acylated glycolurils, such as tetraacetylgylcoluril (TAGU); triacetylcyanurate and sodium sulphophenyl ethyl carbonic acid ester.

A particularly preferred activator is N,N,N¹N¹⁻-tetraacetylethylene diamine (TAED). The activator may be incorporated as fine particles or even in granular form, such as described in the applicants' UK patent specification GB 2 053 998 A. Specifically, it is preferred to have an activator of an average particle size of less than 150 micrometers, which gives significant improvement in bleach efficiency. The sedimentation losses, when using an activator with an average particle size of less than 150 μm, are substantially decreased. Even better bleach performance is obtained if the average particle size of the activator is less than 100 μm. However, too small a particle size can give increased decomposition and handling problems prior to processing. However, these particle sizes have to be reconciled with the requirements for dispersion in the solvent (it will be recalled that the aforementioned first product from requires particles which are as small as possible within practical limits). Liquid activators may also be used, e.g. as hereinafter described.

The organic peroxyacid compound bleaches (which in some cases can also act as structurants/deflocculants) are preferably those which are solid at room temperature and most preferably should have a melting point of at least 50° C. Most commonly, they are the organic peroxyacids and water-soluble salts thereof having the general formula

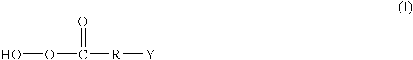

wherein R is an alkylene or substituted alkylene group containing 1 to 20 carbon atoms or an arylene group containing from 6 to 8 carbon atoms, and Y is hydrogen halogen, alkyl, aryl or any group which provides an anionic moiety in aqueous solution. Such Y groups can include, for example:

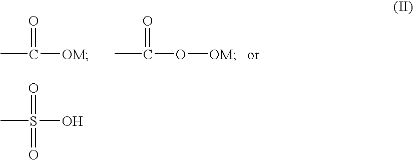

wherein M is H or a water-soluble, salt-forming cation.

The organic peroxyacids and salts thereof usable in the present invention can contain either one, two or more peroxy groups and can be either aliphatic or aromatic. When the organic peroxyacid is aliphitic, the unsubstituted acid may have the general formula:

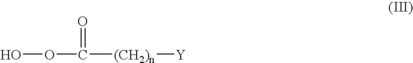

wherein Y can be H, —CH₃, —CH₂Cl,

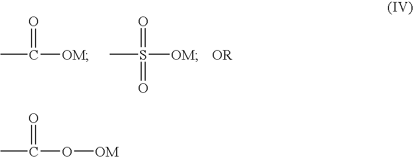

And n can be an integer from 60 to 20. Peroxydodecanoic acids, peroxytetradecanoic acids and peroxyhexadecanoic acids are the most preferred compounds of this type, particularly 1,12-diperoxydodecandioic acid (sometimes known as DPDA), 1,14-diperoxytetradecandioic acid and 1,16-diperoxyhexadecandioic acid. Examples of other preferred compounds of this type are diperoxyazelaic acid, diperoxyadipic and diperoxysebacic acid.

When the organic peroxyacid is aromatic, a unsubstituted acid may have the general formula:

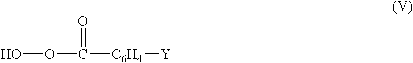

wherein Y is, for example hydrogen, halogen, alkyl or a group as defined for formulae (IV) above.

The percarboxy and Y groupings can be in any relative position around the aromatic ring. The ring and/or Y group (if alkyl) can contain any non-interfering substitutents such as halogen or sulphonate groups. Examples of suitable aromatic peroxyacids and saltes thereof include monoperoxyphthalic acid, diperoxyterephthalic acid, 4-chlorodiperoxy-phthalic acid, diperoxyisophthalic acid, peroxy benzoic acids and ring-substituted peroxy benzoic acids, such as peroxy-alpha-naphthoic acid. A preferred aromatic peroxyacid is diperoxyisophthalic acid.

Another preferred class of peroxygen compounds which can be incorporated to enhance dispensing/dispersibility in water are the anyhdrous perborates described for that purpose in the applicants' European patent specification EP-A-217 454.

It is also preferred to include in the compositions, a stabiliser for the bleach or bleach system, for example ethylene diamine tetramethylene pholphonate and diethylene triamine pentamethylene phosphonate or other appropriate organic phosphonate or salt thereof, such as the Dequest range hereinbefore described. These stabilisers can be used in acid or salt form which as the calcium, magnesium, zinc or aluminium salt form. The stabiliser may be present at a level of up to about 1% by weight, preferably between about 0.1% and about 0.5% by weight.

Since many bleaches and bleach systems are unstable in aqueous liquid detergents and/or other interact unfavourably will other components in the composition, e.g. enzymes, they may for example be protected, e.g. by encapsulation or by formulating a structured liquid composition, whereby they are suspended in solid form.

Other Optional Ingredients

The compositions herein can further comprise a variety of optional ingredients. A wide variety of other ingredients useful in detergent compositions can be included in the compositions herein, including other active ingredients, carriers, hydrotropes, processing aids, dyes or pigments, solvents for liquid formulations, solid fillers for bar compositions, etc. If high sudsing is desired, suds boosters such as the C10-C16 alkanolamides can be incorporated into the compositions, typically at 1%-10% levels. The C10-C14 monoethanol and diethanol amides illustrate a typical class of such suds boosters. Use of such suds boosters with high sudsing; adjunct surfactants such as the amine oxides, betaines and sultaines noted above is also advantageous. If desired, soluble magnesium salts such as MgCl₂, MgSO₄, and the like, can be added at levels of, typically,0.1%-2%, to provide additional suds and to enhance grease removal performance.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

By this means, ingredients such as the aforementioned, bleaches, bleach activators, bleach catalysts, photoactivators, dyes, fluorescers, fabric conditioners and hydrolyzable surfactants can be “protected” for use in detergents, including liquid laundry detergent compositions.

Liquid detergent compositions can contain water and other solvents as carriers.

Chelating Agents

The detergent compositions herein may also optionally contain one or more iron, copper and/or manganese chelating agents. Such chelating agents can be selected from the group consisting of amino carboxylates, amino phosphonates, polyfanctionally-substituted aromatic chelating agents and mixtures therein, all as hereinafter defined.

If utilized, these chelating agents will generally comprise from about 0.1% to about 10% by weight of the detergent compositions herein. More preferably, if utilized, the chelating agents will comprise from about 0.1% to about 3.0% by weight of such compositions.

Clay Soil Removal/Anti-Redeposition Agents

The compositions of the present invention can also optionally contain water-soluble ethoxylated amines having clay soil removal and antiredeposition properties.

Liquid detergent compositions typically contain about 0.01% to about 5% of these agents.

One preferred soil release and anti-redeposition agent is ethoxylated tetraethylenepentamine. Exemplary ethoxylated amines are further described in U.S. Pat. No. 4,597,898,

Another type of preferred antiredeposition agent includes the carboxy methyl cellulose (CMC) materials. These materials are well known in the art.

Brightener

Any optical brighteners or other brightening or whitening agents known in the art can be incorporated at levels typically from about 0.05% to about 1.2%, by weight, into the detergent compositions herein. Commercial optical brighteners which may be useful in the present invention can be classified into subgroups, which include, but are not necessarily limited to, derivatives of stilbene, pyrazoline, cournarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Suds Suppressors

Compounds for reducing or suppressing the formation of suds can be incorporated into the compositions of the present invention. Suds suppression can be of particular importance in the so-called “high concentration cleaning process” as described in U.S. Pat. Nos. 4,489,455 and 4,489,574 and infront-loading European-style washing machines.

A wide variety of materials may be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of particular interest encompasses monocarboxylic fatty acid and soluble salts therein. See U.S. Pat. No. 2,954,347. The monocarboxylic fatty acids and salts thereof used as suds suppressor typically have hydrocarbyl chains of 10 to about 24 carbon atoms, preferably 12 to 18 carbon atoms.

Suitable salts include the alkali metal salts such as sodium, potassium, and lithium salts, and ammonium and alkanolammonium salts.

The detergent compositions herein may also contain non-surfactant suds suppressors. These include, for example: high molecular weight hydrocarbons such as paraffin, fatty acid esters (e.g., fatty acid triglycerides), fatty acid esters of monovalent alcohols, aliphatic C 18-C40 ketones (e.g., stearone), etc.

The preferred category of non-surfactant suds suppressors comprises silicone suds suppressors. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressors are well known in the art and are, for example, disclosed in US-A-4,265,779.

For any detergent compositions to be used in automatic laundry washing machines, suds should not form to the extent that they overflow the washing machine.

Suds suppressors, when utilized, are preferably present in a “suds suppressing amount.”

By “suds suppressing amount” is meant that the formulator of the composition can select an amount of this suds controlling agent that will sufficiently control the suds to result in a low-sudsing laundry detergent for use in automatic laundry washing machines.

The compositions herein will generally comprise from 0.1% to about 5% of suds suppressor.

Fabric Softeners

Various through-the-wash fabric softeners, especially the impalpable smectite clays of U.S. Pat. No. 4,062,647 as well as other softener clays known in the art, can optionally be used typically at levels of from about 0.5% to about 10% by weight inthe present compositions to provide fabric softener benefits concurrently with fabric cleaning. Clay softeners can be used in combination with amine and cationic softeners as disclosed, for example, in U.S. Pat. Nos. 4,375,416 and 4,291,071.

Dye Transfer Inhibiting Agents

The compositions of the present invention may also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%.

Other than in the examples, or where otherwise indicated, all numbers expressing quantities of ingredients or reaction conditions used herein are to be understood as modified in all instances by the term “about”. Similarly, all percentages are weight/weight percentages of the carbon dioxide unless otherwise indicated. Where the term “comprising” is used in the specification or claims, it is not intended to exclude any terms, steps or features not specifically recited.

The liquid detergent compositions according to the present invention may be used for laundry cleaning, hard surface cleaning (including cleaning of lavatories, kitchen work surfaces, floors, mechanical ware washing etc.).

Preferably, the aqueous medium has a pH in the range from pH 6 to 13, more preferably from pH 6 to 11, and most preferably from 7 to 10.

Use and Application

The third aspect of the present invention, when applied to laundry cleaning, is not limited to those circumstances in which a washing machine is employed, but can be applied where washing is performed in some alternative vessel. In these circumstances it is envisaged that the organic substance in liquid composition can be delivered by means of slow release from the bowl, bucket or other vessel which is being employed, or from any implement which is being employed, such as a brush, bat or dolly, or from any suitable applicator for liquid compositions.

Suitable pre-treatment means for application of the organic substance from the liquid composition to the textile material prior to the main wash include sprays, pens, roller-ball devices and impregnated cloths or cloths containing microcapsules. Such means are well known in the analogous art of deodorant application and/or in spot treatment of textiles. Similar means for application are employed in those embodiments where the organic substance in liquid composition is applied after the main washing and/or conditioning steps have been performed, e.g. prior to or after ironing or drying of the cloth. For example, the organic substance in liquid composition may be applied using tapes, sheets or sticking plasters coated or impregnated with the substance, or containing microcapsules of the substance. The polyoxometalate in liquid composition may for example be incorporated into a drier sheet so as to be activated or released during a tumble-drier cycle, or the organic substance in liquid composition can be provided in an impregnated or microcapsule-containing sheet so as to be delivered to the textile when ironed.

The invention will now be further illustrated by way of the following non-limiting examples:

### EXAMPLES

The following example formulation was prepared:

### Formulation Examples

### Example 1

| | Parts by |
|---|---|
| Ingredient | Weight |
| LAS-acid | 7.02 |
| sLES | 13.13 |
| Coconut fatty acid | 1.00 |
| NI 7EO | 8.25 |
| NaOH | 0.63 |
| Monoethanolamine | 0.25 |
| Sodium Citrate 2aq | 4.00 |
| Sodium tetraborate. | 3.81 |
| 5aq | |
| Sorbitol | 4.06 |
| PPG | 4.42 |
| Fluorescer | 0.26 |
| Protease Enzyme | 0.4 |
| (4%) | |
| Minors | 0.63 |
| Water | Balance |

PPG = propylene glycol
LAS acid = C₁₀-C₁₄ alkyl benzene sulphonic acid
sLES = sodium lauryl ether sulphate (average 3 ethyleneoxy units)
NI xEO = C₁₂-C₁₃ fatty alcohol ethoxylated with an average of x ethyleneoxy units.

Polyoxometalate (Me₃NH)₄(NbO₂)PW₁₁O₃₉ disclosed in Racherla et al, EP-A-1 141 210 was dosed at 0.5% by weight on top of the control composition above.

Residual enzyme activity upon storage at 37° C. was found to be as follows:

### Example 1

| | Control | +0.5% Polyoxometalate |
|---|---|---|
| | Avg. | Avg. |
| Days | RA (%) | RA (%) |
| 0 | 100 | 100 |
| 7 | 92 | 100 |
| 14 | 81 | 96 |
| 28 | 60 | 96 |

1. An aqueous liquid cleaning composition comprising a proteolytic enzyme and a primary stabiliser therefor, the composition further comprising a polyoxometalate.

2. A liquid cleaning composition according to claim 1, comprising from 1% to 90% by weight of surfactant.

3. A liquid cleaning composition according to claim 1, wherein the primary enzyme stabiliser comprises a boron enzyme stabiliser.

4. A liquid cleaning composition according to claim 1, wherein the boron enzyme stabiliser is selected from boric acid, sodium metaborate, sodium tetraborate and mixtures thereof.

5. A liquid cleaning composition according to claim 1, wherein the primary enzyme stabiliser comprises a non-boron enzyme stabiliser.

6. A liquid cleaning composition according to claim 1, wherein the non-boron enzyme stabiliser is selected from sources of calcium ions, modified peptides and mixtures thereof.

7. A liquid cleaning composition according to claim 1, comprising from 0.001% to 10% preferably from 0.005% to 7.5%, more preferably from 0.05% to 2.5% by weight of the polyoxometalate.

8. A liquid cleaning composition according to claim 1, wherein the proteolytic enzyme is selected from subtilisins and modified bacterial serine proteases. .

9. A liquid cleaning composition according to claim 1, comprising from 0.001 mg to 3 mg active enzyme per gram of the composition of proteolytic enzyme.

10. A liquid cleaning composition according to claim 1, wherein the polyoxometalate has the formula (I):
(Q)_{q}(AₐXₓMₘO_{y}Z_{z}(H₂O)_{b})cH₂O (I)
where Q, A, X, M, Z, q, a, x, m, y, z, b and c are defined as follows:
Q is one or more cations selected from the group consisting of H, Li, K, Na, Rb, Cs, Ca, Mg, Sr, Ba, Al, PR¹R²R³R⁴ and NR¹R²R³R⁴, in which R¹, R², R³ and R⁴ are identical or different and are H, C₁-C₂₀-alkyl, C₅-C₈-cycloalkyl or C₆-C₂₄-aryl;
q is a number from 1 to 60, in particular from 1 to 40, and for monovalent countercations simultaneously describes the charge of the anionic unit;
A is one or more transition metals from subgroups 2 to 8, preferably Mn, Ru, V, Ti, Zr, Cr, Fe, Co, Zn, Ni, Re and Os, particularly preferably Mn, Ru, V, Ti, Fe, Co and Zn;
a is a number from 0 to 10, preferably from 0 to 8;
X is one or more atoms selected from the group consisting of Sb, S, Se, Te, Bi, Ga, B, P, Si, Ge, F, Cl, Br and 1, preferably P, B, S, Sb, Bi, Si, F, Cl, Br and I;
x is a number from 0 to 10, preferably 0 to 8;
M is one or more transition metals selected from the group consisting of Mo, W, Nb, Ta and V;
m is a number from 0.5 to 60, preferably 4 to 10;
Z is one or more anions selected from the group consisting of OH⁻, F⁻, Cl^{—}, Br⁻, I⁻, N₃⁻, NO₃⁻,
ClO₄⁻, NCS⁻, SCN⁻, PF₆⁻, RSO₃⁻, RSO₄⁻, CF₃SO₃⁻, BR₄⁻, BF₄⁻, CO₃COO⁻ where R is H, C₁-C₂₀-alkyl, alkyl, C₅-C₈-cycloalkyl or C₆-C₂₄-aryl;
z is a number from 0 to 10, preferably from 0 to 8;
O is oxygen;
y is the number of oxygen atoms required for structure/charge compensation, and b and c independently of one another are numbers from 0 to 50, preferably from 0 to 30.

11. A liquid cleaning composition according to claim 10, wherein the polyoxometalate is selected from
Q₅CO(III)W₁₂O₄₀ (Q=K, Na, NMe, NBu, or a mixture of these)
K₅Mn(III)SiW₁₁O₃₉
(Me₃NH)₄(NbO₂)PW₁₁O₃₉
Na₆Co(III)AIW₁₁O₄₀H₂
K₁₀[β-Cu₃SiW₉O₄₀H₃]
K₉[P₂V₃W₁₇O₆₂H2]
Na₁₂[WMn₂(H₂O)₂(ZnW₉O₃₄)]
Na₁₆[Cu₄(H₂O)₂(P₂W₁₅O₅₆)₂]
Na₁₀[Mn₄(H₂O)₂(PW₉O₃₄)]
(NH₄)₁₄[NaP₅W₃₀O₁₁₀]*
(Me₃NH)₄(NbO₂)PW₁₁O₃₉
*=containing water of crystallization and mixtures thereof.

12. A liquid cleaning composition according to claim 1, having a pH value in the range from pH 6 to 11.

13. A liquid cleaning composition according to claim 12, wherein the composition has a pH value in the range from pH 7 to 10.

14. A liquid cleaning composition according to claim 1, wherein the medium is substantially devoid of a transition metal sequestrant.

15. A liquid cleaning composition according to claim 1, wherein the medium further comprises a builder.

16. A method of cleaning a substrate comprising applying to the substrate , an aqueous liquid cleaning composition according to claim 1.

17. A method according to claim 16, wherein polyoxometalate has the general formula (I):
(Q)_{q}(AₐXₓMₘO_{y}Z_{z}(H₂O)_{b})cH₂O (I)
where Q, A, X, M, Z, q, a, x, m, y, z, b and c are defined as follows:
Q is one or more cations selected from the group consisting of H, Li, K, Na, Rb, Cs, Ca, Mg, Sr, Ba, Al, PR¹R²R³R⁴ and NR¹R²R³R⁴, in which R¹, R², R³ and R⁴ are identical or different and are H, C₁-C₂₀-alkyl, C₅-C₈-cycloalkyl or C₆-C₂₄-aryl;
q is a number from 1 to 60, in particular from 1 to 40, and for monovalent countercations simultaneously describes the charge of the anionic unit;
A is one or more transition metals from subgroups 2 to 8, preferably Mn, Ru, V, Ti, Zr, Cr, Fe, Co, Zn, Ni, Re and Os, particularly preferably Mn, Ru, V, Ti, Fe, Co and Zn;
a is a number from 0 to 10, preferably from 0 to 8;
X is one or more atoms selected from the group consisting of Sb, S, Se, Te, Bi, Ga, B, P, Si, Ge, F, Cl, Br and I, preferably P, B, S, Sb, Bi, Si, F, Cl, Br and I;
x is a number from 0 to 10, preferably 0 to 8;
M is one or more transition metals selected from the group consisting of Mo, W, Nb, Ta and V;
m is a number from 0.5 to 60, preferably 4 to 10;
Z is one or more anions selected from the group consisting of OH⁻, F⁻, Cl⁻, Br⁻, I⁻, N₃⁻, NO₃⁻, Cl₄⁻, NCS⁻, SCN⁻, PF₆⁻, RSO₃⁻, RSO₄⁻, CF₃SO₃⁻, BR₄⁻, BF₄⁻, CH₃COO⁻ where R is H, C₁-C₂₀-alkyl, C₅-C₈-cycloalkyl or C₆-C₂₄-aryl;
z is a number from 0 to 10, preferably from 0 to 8;
O is oxygen;
y is the number of oxygen atoms required for structure/charge compensation, and b and c independently of one another are numbers from 0 to 50, preferably from 0 to 30.

18. A method according to claim 16, wherein the polyoxometalate is selected from Q₅Co(III)W₁₂O₄₀ (Q=K, Na, NMe, NBu, or a mixture of these)
K₅Mn(III)SiW₁₁O₃₉
(Me₃NH)₄(NbO₂)PW₁₁O₃₉
Na₆Co(III)AlW₁₁O₄₀H₂
K₁₀8 β-Cu₃SiW₉O₄₀H₃]
K₉[P₂V₃W₁₇O₆₂H₂]
Na₁₂[WMn₂(H₂O)₂(ZnW₉O₃₄)₂]
Na₁₆[Cu₄(H₂O)₂(P₂W₁₅O₅₆)₂]
Na₁₀[Mn₄(H₂O)₂(PW₉_{O}₃₄)₂]
(NH₄)₁₄[NaP₅W₃₀O₁₁₀]*
(Me₃NH)₄(NbO₂)PW₁₁O₃₉
*=containing water of crystallization and mixture thereof.

19. Use of a polyoxometalate as a secondary enzyme stabiliser in an aqueous liquid detergent composition comprising a proteolytic enzyme and a primary stabiliser therefor.
